(19) United States
(12) Patent Application Publication
(10) Pub. No.: US 2021/0065408 A1
(43) Pub. Date: Mar. 4, 2021

(54) CONTENT GENERATION N A VISUAL ENHANCEMENT DEVICE

(71) Applicant: YUTOU TECHNOLOGY (HANGZHOU) CO., LTD., Hangzhou City (CN)

(72) Inventors: Yiming CHEN, Hangzhou City (CN); Haichao ZHU, Hangzhou City (CN)

(21) Appl. No.: 16/555,715

(22) Filed: Aug. 29, 2019

(51) Int. Cl. G06T 11/00; G06T 7/90; G06T 7/11

(52) U.S. Cl. CPC G06T 11/001; G06T 7/90; G06T 2207/10024; G06T 2210/62; G06T 7/11

(57) ABSTRACT

Aspects for content generation in a virtual reality (VR), an augmented reality (AR), or a mixed reality (MR) system (collectively “visual enhancement device”) are described herein. As an example, the aspects may include an image sensor configured to collect color information of an object and a color distance calculator configured to respectively calculate one or more color distances between a first color of a first area of the object and one or more second colors. The aspects may further include a color selector configured to select one of the one or more second colors based on a pre-determined color distance and a content generator configured to generate content based on the selected second color.

### BACKGROUND

A visual enhancement system may refer to a head-mounted device that provides supplemental information associated with real-world objects. For example, the visual enhancement system may include a near-eye display configured to display supplemental information. Typically, the supplemental information may be displayed adjacent to or overlapped with the real-world objects. For instance, a movie schedule may be displayed by a movie theater such that the user may not need to search for movie information when he/she sees the movie theater. In another example, a name of a perceived real-world object may be displayed adjacent to the object or overlapped with the object.

Conventionally, the supplemental information may be displayed in a color regardless of the color of the perceived object. For example, the supplemental information may be displayed in green either adjacent to a yellow banana or a green apple. Thus, the supplemental information may not be displayed in sufficient contrast to the object to be perceived by users.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One example aspect of the present disclosure provides an example visual enhancement device. The example aspect may include an image sensor configured to collect color information of an object; a color distance calculator configured to respectively calculate one or more color distances between a first color of a first area of the object and one or more second colors; a color selector configured to select one of the one or more second colors based on a pre-determined color distance; and a content generator configured to generate content based on the selected second color.

Another example aspect of the present disclosure provides an example method for content generation in a visual enhancement device. The example method may include collecting, by an image sensor, color information of an object; respectively calculating, by a color distance calculator, one or more color distances between a first color of a first area of the object and one or more second colors; selecting, by a color selector, one of the one or more second colors based on a pre-determined color distance; and generating, by a content generator, content based on the selected second color.

To the accomplishment of the foregoing and related ends, the one or more aspects comprise the features herein after fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of visual enhancement device configured to generate content in accordance with the present disclosure;

FIG. 2 further illustrates the components of the example visual enhancement device configured to generate content in accordance with the present disclosure;

FIG. 3 illustrates the generated content that may be positioned by the visual enhancement device; and

FIG. 4 is a flow chart of an example method for content generation in the visual enhancement device.

### DETAILED DESCRIPTION

Various aspects are now described with reference to the drawings. In the following description, for the purpose of explanation, numerous specific details are set forth in order to provide a thorough understanding of one or more aspects. It may be evident, however, that such aspect(s) may be practiced without these specific details.

In the present disclosure, the term “comprising” and “including” as well as their derivatives mean to contain rather than limit; the term “or”, which is also inclusive, means and/or.

In this specification, the following various embodiments used to illustrate principles of the present disclosure are only for illustrative purpose, and thus should not be understood as limiting the scope of the present disclosure by any means. The following description taken in conjunction with the accompanying drawings is to facilitate a thorough understanding to the illustrative embodiments of the present disclosure defined by the claims and its equivalent. There are specific details in the following description to facilitate understanding. However, these details are only for illustrative purpose. Therefore, persons skilled in the art should understand that various alternation and modification may be made to the embodiments illustrated in this description without going beyond the scope and spirit of the present disclosure. In addition, for clear and concise purpose, some known functionality and structure are not described. Besides, identical reference numbers refer to identical function and operation throughout the accompanying drawings.

A visual enhancement device disclosed hereinafter may include two lenses mounted to a wearable frame such that a user may wear the visual enhancement device and view real-world objects via the lenses. The visual enhancement device may further include one or more image sensors to collect color information of the real-world objects. Based on the color information, the visual enhancement device may be configured to determine a color for content to be generated such that the content may be in sufficient contrast to the real-world objects.

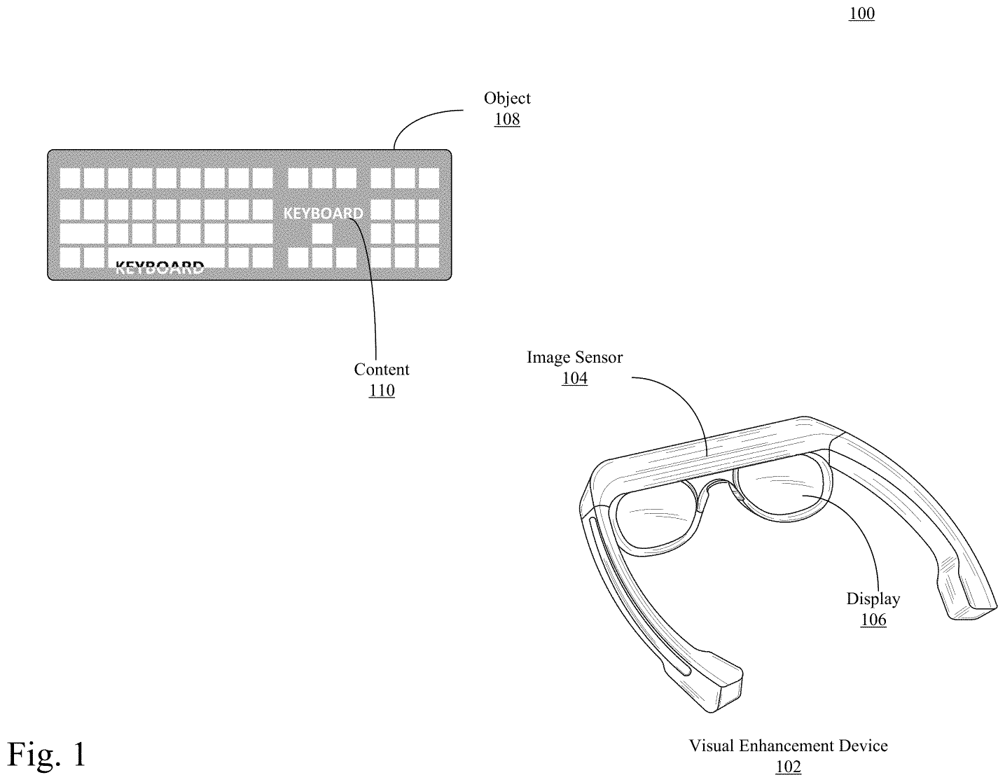

FIG. 1 illustrates an example of visual enhancement device configured to generate content in accordance with the present disclosure. As depicted, a visual enhancement device 102 may include an image sensor 104 and a display 106 integrated with one or more lenses. When an object 108 is within a predetermined area of the field of view of the visual enhancement device or a user wearing the visual enhancement device 102 stares at the object 108, the image sensor 104 may be configured to collect color information of the object 108.

Based on the color information of the object 108, the visual enhancement device 102 may be configured to determine a color and generate content 110 based on the color such that the content 110 in the determined color is in sufficient contrast to the object 108 to be perceived by a user. In the example illustrated in FIG. 1, the image sensor 104 may be configured to collect color information of the object 108 and determine the color of the object 108 is gray. The visual enhancement device 102 may be configured to select a color from a predetermined group of colors and generate content 110 in the selected color, e.g., white, such that the content 110 and the object 108 are in highest contrast. The content 110 may be displayed by the display 106 at a position overlapping at least a portion of the object 108 when viewed by the user. For example, the visual enhancement device 102 may be configured to recognize that the object 108 is a keyboard and generate the name of the object 108, e.g., the word “keyboard,” as the content 110. The word “keyboard” may then be displayed overlapping a portion of the object 108 by the display 106.

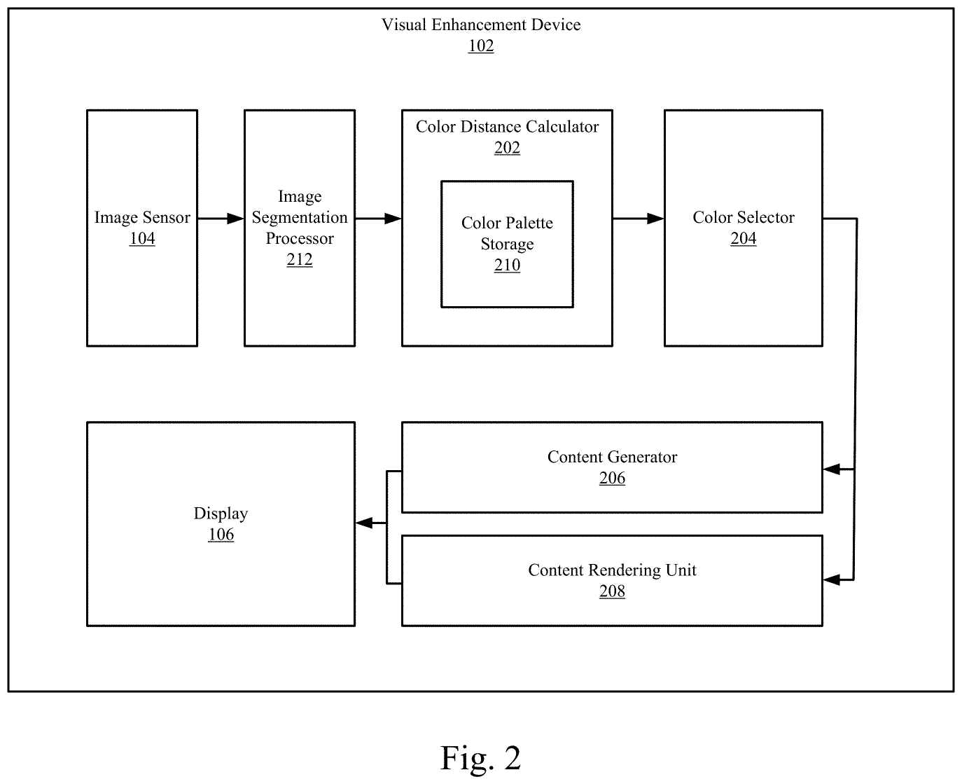

FIG. 2 further illustrates components of the example visual enhancement device configured to generate content in accordance with the present disclosure.

As depicted, the image sensor 104 may be configured to collect image information either continuously or periodically at a predetermined frequency, e.g., 120 Hz. The collected image information may include at least color information of the object 108 and/or other objects that can be viewed by the user of the visual enhancement device via the lenses. The collected image information may be processed an image segmentation processor 212.

In at least some examples, the image segmentation processor 212 may be configured to segment an image into one or more areas such that the object 108 may be recognized from the background. Further, the image segmentation processor 212 may be configured to further segment an image of the object 108 into one or more areas based on the colors at different parts of the object 108 in accordance with image segmentation algorithms, e.g., the mean shift segmentation algorithm. For example, an image of a soccer ball may be segmented into multiple areas based on the colors of the surface of the soccer ball, e.g., one or more areas corresponding to black parts and other areas corresponding to white parts of the soccer ball.

Based on the image of the object 108 and the segmentation results thereof, a color distance calculator 202 may be configured to determine a color with respect to each area of the image of object 108. For example, the color distance calculator 202 may be configured to average the color values in each area of the image of the object 108 to generate a color of a corresponding area.

With respect to each area of the image of the object 108, the color distance calculator 202 may be configured to calculate one or more color distances between the color of the corresponding area and one or more predetermined colors. For example, the color distance calculator 202 may include a color palette storage 210 that stores one or more predetermined colors. In some examples, colors may be represented in three values in CIELAB color space, respectively, L, a and b.

The color distance calculator 202 may be configured to calculate a color distance between the color of the corresponding area and one of the predetermined colors in the color palette storage 210 in accordance with the following formula.

|δ_{x,y}|=\sqrt{(Lₓ−L_{y})²+(aₓ−a_{y})²+(bₓ−b_{y})²}

in which Lₓ, aₓ, and bₓ refer to the three values that represent the color of corresponding area, and L_{y}, a_{y}, and b_{y} refer to the three values that represent the predetermined color.

Further, the color distance calculator 202 may be configured to determine a pre-determined color distance among the color distances calculated with respect to the one or more predetermined colors. A color selector 204 may be configured to select one from the one or more predetermined colors that corresponds to the pre-determined color distance. Thus, with respect to each area of the image of the object 108, a color is selected by the color selector 204. In one embodiment, the pre-determined color distance is a maximum color distance among the calculated color distances. The color selector 204 may be configured to select one from the predetermined colors that corresponds to the maximum color distance. In another embodiment, the pre-determined color distance may refer to a pre-defined threshold color distance. In this embodiment, the color selector 204 may be configured to randomly select one predetermined color that corresponds to a color distance that is greater than the pre-defined threshold color distance. In yet another embodiment, the color distance may be offset by a pre-determined value to adapt to the different transparency of the lens and/or light intensity of the environment.

Information of the selected color may be transmitted to a content generator 206. The content generator 206 may be configured to generate content in the selected color. In some examples, the content generator 206 may be configured to recognize the object 108 in accordance with pattern recognition algorithms. In these examples, the generated content may be text or word, e.g., name of the object 108 (keyboard). In some other examples, the content generator 206 may be configured to determine relevant information of the object 108, e.g., manufacturer of the object 108, based on other information, e.g., barcodes attached to the object 108. In these examples, the content may be the manufacturer of the keyboard.

A content rendering unit 208 may be configured to determine a position of the generated content.

In at least some examples, the content rendering unit 208 may be configured to superimpose the generated content on one or more areas of the object 108. Alternatively, the content rendering unit 208 may be configured to place the generated content in a position such that at least a part of the generated content overlaps with an area of the object 108.

Since one or more colors may be selected with respect to the different areas of the object 108, different parts of the generated content may be displayed in different colors respectively.

Further, in at least some examples, the content rendering unit 208 may be configured to adjust a transparency of the generated content, e.g., from 0% (non-transparent) to 75%.

The display 106 may then be configured to display the generated content at a position determined by the content rendering unit 208.

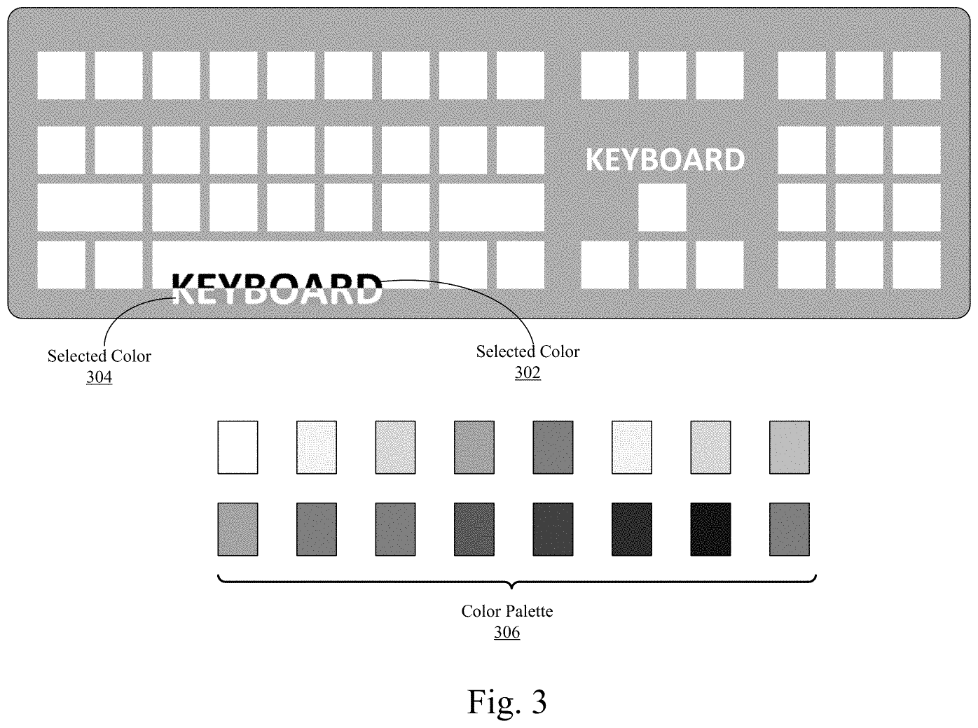

FIG. 3 illustrates the generated content that may be positioned by the visual enhancement device. In the non-limiting example illustrated in FIG. 3, the object 108 is a keyboard with keys in white and a frame in gray.

The image sensor 104 may be configured to collect color information of the keyboard and transmit the color information to the image segmentation processor 212.

Based on the aforementioned the mean shift segmentation algorithm, the image segmentation processor 212 may be configured to segment the image of the keyboard into multiple areas based on the respective color information. For example, each key may be segmented as one area and the frame may be determined as one area.

With respect to each segmented area of the image of object 108, the color distance calculator 202 may be calculate a color of the corresponding area by averaging the color values of the respective area. For example, the color for each key may be calculated as white and the color for the frame may be calculated as grey.

The color distance calculator 202 may be further configured to calculate one or more color distances between the calculated color of each area and each color in a color palette 306. A maximum color distance may be selected from the calculated color distances with respect to each area of the image of the object 108.

With respect to each area of the image of the object 108, the color selector 204 may be configured to select a color from the colors in the color palette 306 based on a pre-determined color distance. In one embodiment, the pre-determined color distance is the maximum color distance. The color selector 204 may be configured select a color from the colors in the color palette 306 that corresponds to the maximum color distance. For example, with respect to the white keys, the color selector 204 may be configured to select black because black corresponds to the maximum color distance. With respect to the gray frame, the color selector may be configured to select white from the color palette 306.

In another example, the pre-determined color distance may refer to a pre-defined threshold color distance. In this example, the color selector 204 may be configured to identify one or more colors from the color palette 306 that correspond to one or more color distances greater than the pre-defined threshold color distance. Further, the color selector 204 may be configured to randomly select one color from the identified one or more color.

The content rendering unit 208 may be configured to determine the position of contents to be generated. For example, the content rendering unit 208 may superimpose contents on top of the frame or overlapping on the space key and the frame.

Based on the position of contents, the content generator 206 may then be configured to generate contents in the selected color. For example, when the position of the content is determined to be within one single area of the object 108, e.g., the frame, the content generator 206 may generate the content in white. When the content is positioned overlapping more than one area of the object 108, the content generator 206 may generate the content in more than one color. For example, when the position of the content is determined to overlap both the area of the space key and the frame, the content generator 206 may be configured to generate the upper portion of the content in the selected color 302, e.g., black, and the lower portion of the content in the selected color 304, e.g., white.

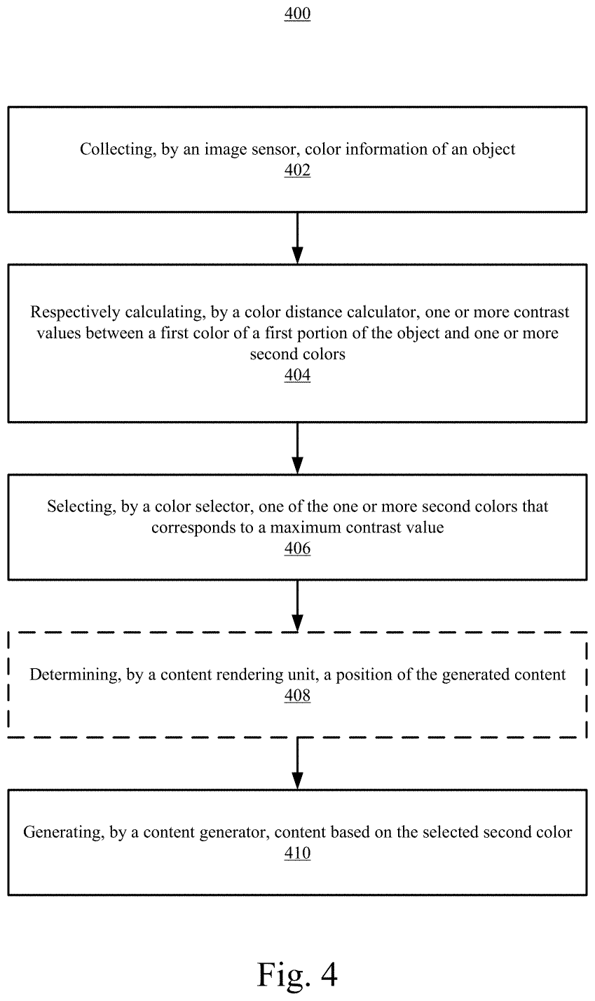

FIG. 4 is a flow chart of an example method for content generation in the visual enhancement device. Operations included in the example method 400 may be performed by the components described in accordance with FIGS. 1 and 2. Dash-lined blocks may indicate optional operations.

At block 402, the example method 400 may include collecting, by an image sensor, color information of an object. For example, the image sensor 104 may be configured to collect image information either continuously or periodically at a predetermined frequency, e.g., 120 Hz. The collected image information may include at least color information of the object 108 and/or other objects that can be viewed by the user of the visual enhancement device via the lenses. The collected image information may be processed an image segmentation processor 212.

In at least some examples, the image segmentation processor 212 may be configured to segment an image into one or more areas such that the object 108 may be recognized from the background. Further, the image segmentation processor 212 may be configured to further segment an image of the object 108 into one or more areas based on different colors of different parts of the object 108 in accordance with the mean shift segmentation algorithm.

At block 404, the example method 400 may include respectively calculating, by a color distance calculator, one or more color distances between a first color of a first area of the object and one or more second colors. For example, color distance calculator 202 may be configured to determine a color with respect to each area of the image of object 108. For example, the color distance calculator 202 may be configured to average the color values in each area of the image of the object 108 to generate a color of each corresponding area.

With respect to each area of the image of the object 108, the color distance calculator 202 may be configured to calculate one or more color distances between the color of the corresponding area and one or more predetermined colors. For example, the color distance calculator 202 may include a color palette storage 210 that stores one or more predetermined colors. In some examples, colors may be represented in three values in CIELAB color space, respectively, L, a and b.

The color distance calculator 202 may be configured to calculate a color distance between the color of the corresponding area and one of the predetermined colors in the color palette storage 210 in accordance with the following formula.

|δ_{x,y}|=\sqrt{(Lₓ−L_{y})²+(aₓ−a_{y})²+(bₓ−b_{y})²}

in which Lₓ, aₓ, and bₓ refer to the three values that represent the color of corresponding area, and L_{y}, a_{y}, and b_{y} refer to the three values that represent the predetermined color.

Further, the color distance calculator 202 may be configured to determine a maximum color distance among the color distances calculated with respect to the one or more predetermined colors.

At block 406, the example method 400 may include selecting, by a color selector, one of the one or more second colors based on a pre-determined color distance. In at least one example, the pre-determined color distance may refer to the maximum color distance. For example, the color selector 204 may be configured to select one from the one or more predetermined colors that corresponds to the maximum color distance. Thus, with respect to each area of the image of the object 108, a color is selected by the color selector 204. In another embodiment, the pre-determined color distance may refer to a pre-defined threshold value. In yet another embodiment, the color distance may be offset by a pre-determined value to adapt to the different transparency of the lens and/or light intensity of the environment.

At block 408, the example method 400 may include determining, by a content rendering unit, a position of the generated content. For example, the content rendering unit 208 may be configured to determine a position of the generated content. In at least some examples, the content rendering unit 208 may be configured to superimpose the generated content on one or more areas of the object 108. Alternatively, the content rendering unit 208 may be configured to place the generated content in a position such that at least a part of the generated content overlaps with an area of the object 108.

At block 410, the example method 400 may include generating, by a content generator, content based on the selected second color. For example, the content generator 206 may be configured to generate content in the selected color. In the example illustrated in FIG. 3, For example, when the position of the content is determined to be within one single area of the object 108, e.g., the frame, the content generator 206 may generate the content in white. When the content is positioned overlapping more than one area of the object 108, the content generator 206 may generate the content in more than one color.

The display 106 may then be configured to display the generated content at a position determined by the content rendering unit 208 such that the content is generated at the determined position from the perspective of the user.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

We claim:

1. A visual enhancement device, comprising:
an image sensor configured to collect color information of an object;
a color distance calculator configured to respectively calculate one or more color distances between a first color of a first area of the object and one or more second colors;
a color selector configured to select one of the one or more second colors based on a pre-determined color distance; and
a content generator configured to generate content based on the selected second color.

2. The visual enhancement device of claim 1, further comprising a content rendering unit configured to determine a position of the generated content.

3. The visual enhancement device of claim 2, wherein the content rendering unit is further configured to superimpose the generated content on the first area of the object from the perspective of a user of the visual enhancement device.

4. The visual enhancement device of claim 2, wherein the content rendering unit is further configured to place the generated content such that at least a portion of the generated content overlaps with the first area of the object from a perspective of a user of the visual enhancement device.

5. The visual enhancement device of claim 1, wherein the color distance calculator is further configured to average color values associated with the first area of the object to generate the first color.

6. The visual enhancement device of claim 2, wherein the content rendering unit is configured to adjust a transparency of the generated content.

7. The visual enhancement device of claim 1, wherein the generated context is text.

8. The visual enhancement device of claim 2, further comprising a display configured to display the generated contents based on the position determined by the content rendering unit.

9. The visual enhancement device of claim 1, further comprising an image segmentation processor configured to identify multiple areas of the object based on the mean shift segmentation algorithm.

10. The visual enhancement device of claim 1,
wherein the pre-determined color distance is a maximum color distance among the calculated one or more color distances, and
wherein the color selector is configured to select the one of the one or more second colors that corresponds to the maximum color distance.

11. The visual enhancement device of claim 1,
wherein the pre-determined color distance is a pre-defined threshold color distance,
wherein the color selector is configured to identify at least one from the one or more second colors that correspond to color distances greater than the pre-defined threshold color distance, and
wherein the color selector is configured to randomly select one from the identified at least one second colors.

12. A method for generating visual content in a visual enhancement device, comprising:
collecting, by an image sensor, color information of an object;
respectively calculating, by a color distance calculator, one or more color distances between a first color of a first area of the object and one or more second colors;
selecting, by a color selector, one of the one or more second colors that corresponds to a pre-determined color distance; and
generating, by a content generator, content based on the selected second color.

13. The method of claim 12, further comprising determining, by a content rendering unit, a position of the generated content.

14. The method of claim 13, further comprising superimposing, by the content rendering unit, the generated content on the first area of the object from a perspective of a user of the visual enhancement device.

15. The method of claim 13, further comprising placing, by the content rendering unit, the generated content such that at least a portion of the generated content overlaps with the first area of the object from a perspective of a user of the visual enhancement device.

16. The method of claim 12, further comprising averaging, by the color distance calculator, color values associated with the first area of the object to generate the first color.

17. The method of claim 12, further comprising adjusting, by the content rendering unit, a transparency of the generated content.

18. The method of claim 12, wherein the generated context is text.

19. The method of claim 13, further comprising displaying, by a display, the generated content based on the position determined by the content rendering unit.

20. The method of claim 12, further comprising identifying, by an image segmentation processor, multiple areas of the object based on the mean shift segmentation algorithm.
